(19) United States
(12) Patent Application Publication
(10) Pub. No.: US 2018/0008919 A1
(43) Pub. Date: Jan. 11, 2018

(54) SOLIDS HANDLING IN WATER TREATMENT SYSTEMS AND ASSOCIATED METHODS

(71) Applicant: Gradiant Corporation, Woburn, MA (US)

(72) Inventor: Edward Francis Tierney, III, South Weymouth, MA (US)

(73) Assignee: Gradiant Corporation, Woburn, MA (US)

(21) Appl. No.: 15/641,617

(22) Filed: Jul. 5, 2017

Related U.S. Application Data
(60) Provisional application No. 62/358,729, filed on Jul. 6, 2016.

(51) Int. Cl. B01D 36/04; B01D 21/00; B01D 21/34; C02F 1/00; C02F 11/12; E21B 41/00; E21B 43/34; C02F 103/10; E21B 43/26

(52) U.S. Cl. CPC B01D 36/04; C02F 11/122; B01D 21/0045; B01D 21/0051; B01D 21/34; E21B 41/00; B01D 21/0042; C02F 1/00; C02F 2103/10; C02F 2001/007; E21B 43/26; E21B 43/34

(57) ABSTRACT

Apparatuses, systems, and methods related to water treatment are generally described. In particular, clarifiers that may improve solids thickening and related systems and methods are disclosed.

### RELATED APPLICATIONS

This application claims priority to U.S. Provisional Application No. 62/358,729, filed Jul. 6, 2016, which is incorporated herein by reference in its entirety.

### TECHNICAL FIELD

Apparatuses, systems, and methods related to water treatment are generally described.

### BACKGROUND

Raw or pretreated sources of water (e.g., produced water from oil and/or gas field operations) often contain high levels of contaminants including high levels of suspended solids. In some cases, it may be desirable to treat water to remove suspended solids to render the water suitable for additional uses or for disposal. Furthermore, the removed suspended solids may form a sludge. It may be desirable to further thicken or dewater the sludge to render it suitable for additional uses or for disposal.

Conventional apparatuses, systems, and methods for treating water and/or thickening a suspended solids product (e.g., sludge) are often expensive and/or poorly suited for many applications (e.g., treating oilfield wastewater). Accordingly, improved apparatuses, systems, and methods for treating water and/or thickening sludge are needed.

### SUMMARY

Apparatuses, systems, and methods related to water treatment are generally described. The subject matter of the present invention involves, in some cases, interrelated products, alternative solutions to a particular problem, and/or a plurality of different uses of one or more systems and/or articles.

According to one or more embodiments, a clarifier for a water treatment system is provided. The clarifier may comprise a separator region fluidically connected to an inlet of the clarifier and a first outlet of the clarifier. The clarifier may further comprise a thickening region below the separator region. The thickening region may comprise a rotatable shaft, protrusions extending outward from the rotatable shaft, and a second outlet fluidically connected to the thickening region. The second outlet may be positioned between a first section of the rotatable shaft and a second section of the rotatable shaft. The second outlet may be positioned in a central portion of a clarifier bottom.

According to one or more embodiments, a method of operating a clarifier for a water treatment system is provided. The method may comprise separating, within a separator region of the clarifier, at least a portion of suspended solids from an aqueous inlet stream to produce a first product and a second product. The first product may be enriched in water relative to the aqueous inlet stream. The first product may be directed to a first outlet of the clarifier. The second product may be positioned below the separator region of the clarifier. The second product may be enriched in solids relative to the aqueous inlet stream. The second product may have a solids content of 2% by weight or greater. The second product may be directed to a second outlet of the clarifier. The second product may be enriched in suspended solids relative to the aqueous inlet stream such that the ratio of a mass percentage of the solids in the second product to a mass percentage of solids in the inlet stream is at least about 20 to 1.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a side view of a clarifier for a water treatment system, according to one or more embodiments;

FIG. 2 is a schematic drawing of a water treatment system, according to one or more embodiments;

FIG. 3 is a side view of a sludge holding tank according to one or more embodiments;

FIG. 4 is a schematic drawing of a control system for use with a water treatment system, according to one or more embodiments;

FIG. 5 is a schematic drawing of a clarifier, according to one or more embodiments;

FIG. 6 is a side view of a clarifier for a water treatment system, according to one or more embodiments; and

FIG. 7 is a side view of a clarifier for a water treatment system, according to one or more embodiments.

### DETAILED DESCRIPTION

Apparatuses, systems, and methods related to water treatment are generally described. Clarifiers may be used in water treatment to separate solids from a feed stream. The solids collect to form a sludge that then exits the clarifier. The sludge may be characterized as having a “thickness,” which is often represented in terms of a percent solids value of the sludge (with the balance being process fluid, such as water). As used herein, the term “water” refers to both pure water and aqueous solutions containing additional components. “Thicker” sludges—in the context of sludge consistency—tend to be more viscous and generally tend to contain a higher percentage of solids, relative to “thinner” sludges.

In certain applications, it is advantageous to increase the percent solids of the sludge exiting the clarifier prior to further downstream thickening applications. In certain modes of operation, increasing the percent solids of the sludge exiting through the sludge outlet improves overall system efficiency. For example, if the sludge is thickened (i.e., percent solids increased) in the clarifier, itself, the flow rate of the sludge removed by pumping from the clarifier may be reduced, while still removing the same amount of solids from the clarifier. In certain such scenarios, downstream sludge handling and dewatering equipment can be downsized, reducing capital and operating expenses.

Sludge may be thickened through the process of compaction by the force of the weight of water and sludge above. Sludge thickening by compaction alone can present problems, in addition to requiring an increased pumping rate. For example, in certain cases where compaction alone is used, the settled sludge tends to be heterogeneous within the thickening region. When being pumped, this can result in formations of “rat holes” and “bridging” within the sludge thickening section. Rat holes sometimes form when sludge is removed at the pump outlet. In those situations, the void left behind is generally quickly filled, often by the less viscous portion of the heterogeneous mixture, such as water with a lower solids content. This lower solids content water generally fills the void as the thicker or more viscous sludge is resistant to flow. As this process continues, the rat holes can become more defined, causing less and less solid material to be removed. In some such scenarios, even as the pumping rate is increased, solids continue to increase causing the sludge blanket level to begin to rise, which can ultimately block sections of plates used in clarification, and causing “jetting” of solids up into the clarified water, resulting in turbid discharge from the clarifier. “Bridging” is a similar condition, where sludge forms bridges due to resistance to flow, blocking sludge flow the pump outlet, causing the same jetting condition described above.

In certain embodiments, a clarifier is disclosed that is capable of increasing the thickness of exiting sludge over and above the thickness achieved by compaction alone and that is capable of ameliorating the problems described above and other known problems associated with removing sludge from the clarifier.

According to one or more embodiments a clarifier for a water treatment system is disclosed herein. The clarifier may comprise a separator region fluidically connected to an inlet of the clarifier and a first outlet of the clarifier. The clarifier may further comprise a thickening region below the separator region.

The thickening region may, in turn, comprise a rotatable shaft, protrusions extending outward from the rotatable shaft, and a second outlet fluidically connected to the thickening region and positioned between a first section of the rotatable shaft and a second section of the rotatable shaft. In some embodiments, the second outlet may be fluidically connected to the thickening region and positioned in a central portion of a clarifier bottom.

According to one or more embodiments, methods or operations may be performed on or with the clarifier. According to one or more embodiments, the clarifier may be operated to provide a product having a higher solids content than that which can be achieved with other clarifiers. According to one or more embodiments, the clarifier may be operated to provide a product enriched in suspended solids such that the ratio of a mass percentage of the solids in the produce to a mass percentage of solids in the inlet stream is greater than that which can be achieved with other clarifiers.

According to one or more embodiments, the clarifier may be incorporated into a water treatment system. Other components and/or stages of the water treatment system may include pretreatment stages, post-treatment stages, sludge thickening and/or dewatering stages, and one or more tanks or locations for holding water and/or further treating the water.

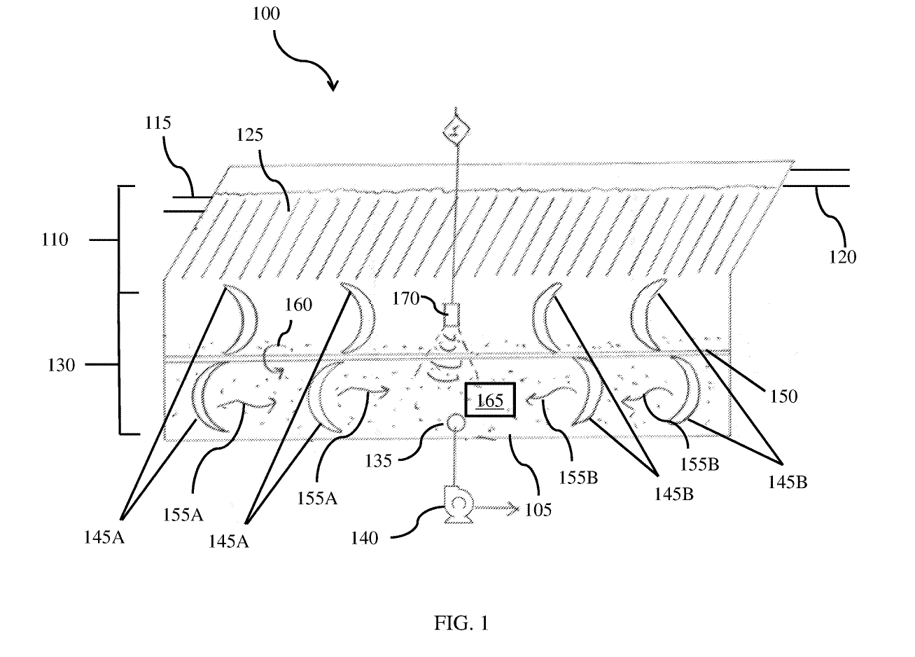

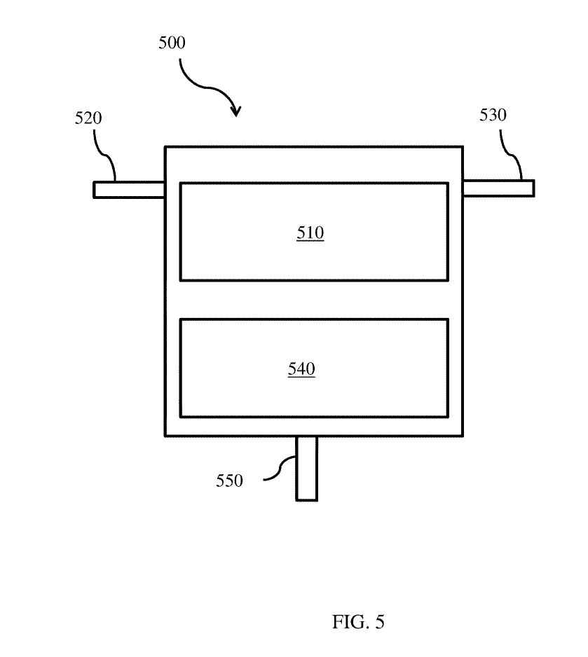

The disclosed clarifier may comprise a separator region. The separator region is, according to certain embodiments, configured to produce a first product stream containing a lower concentration of suspended solids than an inlet stream of the clarifier. In the separator region, according to certain embodiments, suspended solids are removed from the feed stream by, for example, encouraging sedimentation of the solids. Examples of the chemical make-up and source of the inlet stream are discussed in further detail below. For example, a representative clarifier 500, shown in FIG. 5, includes a separator region 510 having an inlet 520 for receiving an inlet stream and an outlet stream 530 from which the first product stream, containing a lower concentration of suspended solids than the inlet stream, exits the clarifier 500. In another example, a representative clarifier 100, shown in FIG. 1, includes an inlet 115 where a water stream comprising suspended solids is directed to a separator region 110. The separator region 110 may be located above a thickening region 130 in the clarifier 100.

In the separator region 110, at least a portion of the suspended solids may be separated from the stream through, for example, sedimentation. The separator region 110 may comprise components that facilitate solids sedimentation. According to certain embodiments, the separator region comprises a plurality of inclined plates. The inclined plates may be configured, according to certain embodiments, to improve the sedimentation rate of solids in the inlet stream. In the embodiment shown in FIG. 1, the separator region 110 comprises a plurality of inclined plates 125 that improve the sedimentation rate of solids in the inlet stream. The separator region may, alternatively or additionally, comprise a plurality of corrugated plates, tube settling media, or other components that aid in the separation of suspended solids from a liquid stream.

According to certain embodiments, the passage of water through the separator region 110 results in the formation of a product stream with a reduced suspended solids concentration. The product stream may exit the clarifier 100 through a first outlet 120.

The plates may have a particular plate spacing. Plate spacing is measured as the vertical distance between the lamella plates. This is the greatest distance a particle between two plates would have to travel before contacting the bottom plate of the two plates. The minimum particle size that can be reliably removed by a clarifier is related to the plate spacing. According to certain embodiments, the plate spacing may be at least 1, 2, or 3 inches. According to certain embodiments, the plate spacing may be less than or equal to 4, 3, or 2 inches. Combinations of the above values are also possible, for example, at least 1 inch and less than or equal to 3 inches.

The clarifier may have a particular surface loading rate. Surface loading rate is calculated by dividing the influent volumetric flow rate by the projected plate area. Projected plate area is calculated by summing the horizontally projected area of all the plates. In some embodiments, the surface loading rate may be at least 0.1, 0.2, 0.25, 0.3, 0.4, 0.5, 0.6, or 0.7 gpm/ft². In some embodiments, the surface loading rate may be less than or equal to 0.75, 0.7, 0.6, 0.5, 0.4, 0.3, 0.25, or 0.2 gpm/ft². Combinations of the above values are also possible, for example, at least 0.2 gpm/ft² and less than or equal to 0.2 gpm/ft².

According to one or more embodiments, the clarifier may comprise a thickening region which receives separated solids. According to certain embodiments, the thickening region comprises a movable surface that facilitates sludge thickening. For example, the representative clarifier 500, shown in FIG. 5, comprises a thickening region 540. The thickening region 540 may comprise a movable surface that aids in thickening a sludge and/or directing the sludge to an outlet 550 fluidically connected to the thickening region 540. In some embodiments, the movable surface may comprise a shaft-driven device. The movable surface may comprise, according to certain embodiments, a rotatable shaft having protrusions extending outward. The movable surface may comprise, for example, picket fence thickeners, paddle wheel thickeners, propeller mixers, augurs, and the like. The movable surface may additionally or alternatively comprise track scrapers or rakes and/or sonication or vibrational devices for directing sludge to the outlet (e.g., outlet 550 in FIG. 5) and/or thickening of sludge. The outlet may be positioned between a first section of the rotatable shaft and a second section of the rotatable shaft, for example, underneath a central section of the rotatable shaft. In some embodiments, the outlet may be positioned in a central portion of the clarifier bottom.

Likewise, the representative clarifier 100, shown in FIG. 1, comprises a thickening region 130 positioned beneath the separator region 110 to receive the suspended solids separated from the inlet stream. During separation, the solids exit the separator region 110 and descend into the thickening region 130. In some embodiments, the solids form a layer on the bottom 105 of the clarifier 100, referred to as a sludge blanket 165. The top of the sludge blanket 165, in some embodiments, forms a solids/water interface where there is a sharp transition from water bearing solids (sludge) to free water. Generally, a sludge blanket level may be expressed in terms of vertical height from a reference point (e.g., the clarifier bottom 105) to the top of the sludge blanket. The region vertically above the sludge blanket to the bottom of the separation apparatus (e.g., inclined plates 125) is known as the clarifier basin. The velocity of the water flowing in the basin is generally kept low (e.g., less than or equal to one foot per second) to avoid disturbing the sludge blanket 165. Characteristics of the sludge blanket 165 may vary over the height of the blanket. For example, the sludge is more concentrated or thicker nearer the bottom 105 of the clarifier, due, in part, to compaction. Sludge “thickness” is expressed in terms of percent solids, a measurement of the percentage of mass or volume of solids, with the remaining mass or volume taken up by the process fluid (e.g., water).

According to certain embodiments, a rotatable shaft having protrusions extending outward from it is provided in the thickening region of the clarifier. The shaft may extend along an entire length of the clarifier thickening region, shown left to right in FIG. 1. the shaft may be slowly rotated causing the protrusions to agitate the sludge blanket, continuously releasing free water from the sludge to the surface. This continuous agitation and release of free water from the sludge blanket not only thickens the sludge, but may also continuously homogenize the sludge blanket. The constant homogenization may break up or inhibit the formation of rat holes and bridges, increasing the percent solids of the sludge exiting the outlet. This homogenized sludge blanket can thereby be pumped off at a reduced pumping rate, such that the rate of effluent solids is equal to the rate of influent solids. Reducing the pumping rate may result in an increased residence time of the sludge thereby allowing the additional benefit of maximum compaction by gravity.

As shown representatively in FIG. 1, protrusions 145A and 145B extend outward from the rotatable shaft 150. In the embodiment shown in FIG. 1, a first set of protrusions 145A are positioned to the left of the outlet 135, while a second set of protrusions 145B are positioned to the right of the outlet 135. The rotation of the shaft 150 is shown by the rotational direction arrow 160. The motion of sludge 165 towards an outlet 135 is shown from the left by sludge flow directional arrows 155A and from the right by sludge flow directional arrows 155B.

According to certain embodiments, the rotatable shaft and protrusions extending therefrom are operated at a particular rotation rate to cause just enough agitation to release water without otherwise disturbing the sludge blanket. An amount of agitation may be based on, for example, a viscosity difference between the sludge blanket and the liquid/solid suspension above the sludge blanket. According to some embodiments, the viscosity of the liquid/solid suspension above the sludge blanket is at least 0.5, 0.8, 1, 2, 3, or 4 cP. In some embodiments, the viscosity of the liquid/solid suspension above the sludge blanket is less than or equal to 5, 4, 3, 2, 1, or 0.8 cP. Combinations of these values are also possible, for example, at least 0.8 and less than or equal to 2 cP. The viscosity of the sludge blanket may depend on the concentration of solids. According to some embodiments, the viscosity of the sludge blanket is at least 5, 50, 100, 200, 500, or 800 cP. According to some embodiments, the viscosity of the sludge blanket is less than or equal to 1000, 800, 500, 200, 100, or 50 cP. Combinations of these values are also possible, for example, at least 50 cP and less than or equal to 200 cP. According to some embodiments the shaft rotates at a rate of at least 1, 2, 3, or 4 RPM. In some embodiments, the shaft rotates at a rate less than or equal to 5, 4, 3, or 2 RPM. Combinations of these values are also possible, for example, at least 1 RPM and less than or equal to 3 RPM.

In some embodiments, the protrusions are designed so as to not themselves impart movement of the sludge in the direction toward the sludge outlet. In such embodiments, the force exerted by a pump, for example, is responsible for movement of the sludge towards the sludge outlet. Alternatively, in some embodiments, the protrusions may be pitched, with opposing pitch on opposite sides of the outlet, to impart directional flow to the sludge toward the location of the sludge outlet.

According to one or more embodiments, the protrusions may comprise blades. According to one or more embodiments, the protrusions may comprise baffles. According to one or more embodiments, the protrusions may be helical-shaped or threaded.

According to one or more embodiments, the rotatable shaft is positioned at a height in the clarifier such that the protrusions travel within the sludge blanket during a first portion of their rotation and travel above the sludge blanket during a second portion of their rotation. According to one or more embodiments, the rotatable shaft may be positioned at a height within the thickening section so as to be located at about the same height at which the sludge blanket level is to be maintained during operation. In other embodiments, the rotatable shaft may be positioned so as to be submerged within the sludge blanket, or, alternatively, above the sludge blanket, during operation. The protrusions may be shaped to encounter limited resistance as they pass through the sludge blanket. According to certain embodiments, the protrusions may be of sufficient length so as to extend above the top of the sludge blanket during a portion of their rotation, as shown for example, in FIG. 1.

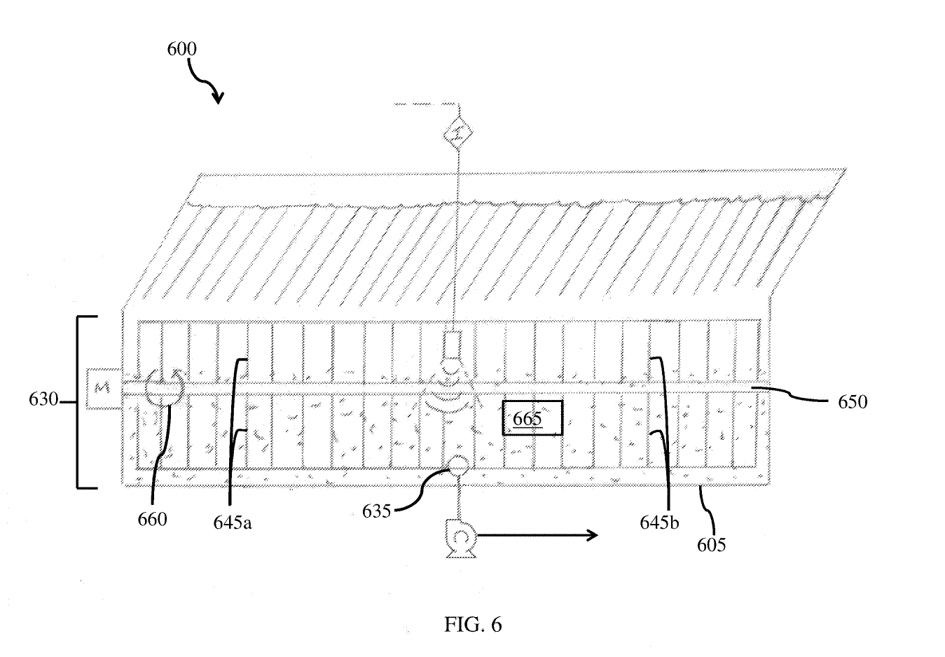

FIG. 6 shows an embodiment of an exemplary clarifier which may be used, for example, for thickening sludge. In FIG. 6, a clarifier 600 comprises a picket fence style thickener for thickening the sludge blanket 665 within a thickening region 630. The clarifier 600 comprises a rotatable shaft 650 having protrusions 645A and 645B extending outward from it. As shown representatively in FIG. 6, protrusions 645A and 645B extend outward from the rotatable shaft 650, which is positioned horizontally across the thickening region 630. A first set of protrusions 645A are positioned to the left of the outlet 635, while a second set of protrusions 645B are positioned to the right of the outlet 635, which is positioned in a central portion (e.g., the central 40%) of a bottom 605 of the clarifier. The rotation of the shaft 650 is shown by the rotational direction arrow 660.

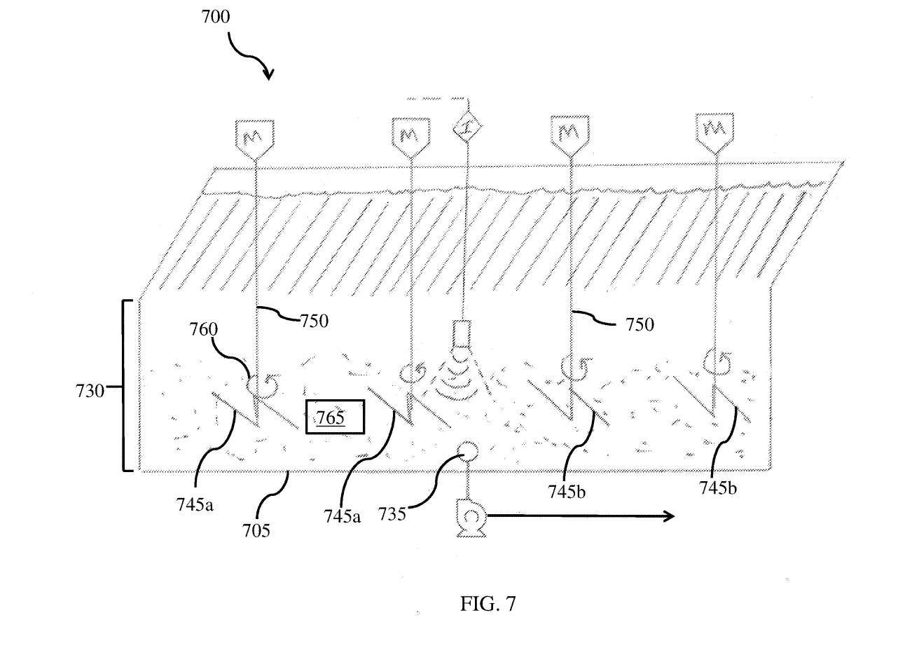

FIG. 7 shows another embodiment of an exemplary clarifier. In the embodiment shown in FIG. 7, a propeller-style thickener is employed for thickening the sludge blanket 765 within a thickening region 730. One or more rotatable shafts 750 are positioned vertically in the clarifier 700. The shafts 750 may have protrusions (e.g., propeller blades) 745A and 745B extending outward from them. A first set of protrusions 745A are positioned to the left of the outlet 735, while a second set of protrusions 745B are positioned to the right of the outlet 735, which is positioned in a central portion of a bottom 705 of the clarifier. The rotation of the shaft 750 is shown by the rotational direction arrow 760.

Sludge may exit the clarifier from the thickening region through a second outlet (e.g., sludge outlet) positioned in the clarifier bottom. In some embodiments, a pump may draw sludge through the second outlet or sludge outlet.

For example, as shown in FIG. 1, a second outlet 135 is positioned on the clarifier bottom 105, and is drawn through the outlet 135 by a pump 140. In some embodiments, the second outlet 135 is positioned in a central portion of the clarifier bottom 105. Generally, the central portion of the clarifier bottom corresponds to the central 40% of surface area of the clarifier bottom. In some embodiments, the central portion could be within a central 30%, 20%, 10%, or 5% of surface area. One can determine whether an outlet lies within the central portion of the clarifier bottom as follows: Taking 40% as an example, one would trace a curve (which could be a straight line in the case of a planar clarifier bottom, or could be curved in the case of a curved clarifier bottom) along the shortest pathway that extends from the geometrical center of the clarifier bottom, through the center of the outlet, and to the nearest edge of the clarifier bottom. If the outlet falls within the 40% of the curve nearest the geometrical center of the clarifier bottom, the outlet would be considered to lie within the central 40% of surface area of the clarifier bottom. Placement of a solids outlet within a central portion of the clarifier bottom provides advantages over a more peripheral placement of the outlet. The sludge blanket over the central portion may be more uniform than the sludge blanket at a periphery. In the central portion of the clarifier, the sludge may be more homogenous because the slowly turning thickener typically spans the central portion. Furthermore, the central portion is located farthest from the clarifier walls. Locations close to the walls experience less mixing. As a result, by placing the outlet at a central location where the above sludge blanket is relatively more uniform, the potential for the formation of a “rat hole” is reduced.

Additionally, at the edges of the thickening region furthest from the sludge outlet, the sludge blanket the height of the sludge blanket may be greatest, therefore locating the outlet in the central portion may reduce the maximum height of the sludge blanket. Operational problems including poor flow distribution and jetting typically originate from the highest point of the sludge blanket, so reducing the height of this point is beneficial.

In some embodiments, the clarifier may comprise a sludge outlet through which a certain minimum percentage of sludge output passes. In some embodiments the clarifier may have a single outlet through which most or all of the sludge exiting the clarifier exits. In some embodiments, the percentage of total sludge output through the sludge outlet is at least 50%, at least 60%, at least 70%, at least 80%, at least 90%, at least 99%, or 100%.

In some embodiments, the system may have a particular sludge volumetric outflow through the sludge outlet. According to some embodiments, the sludge volumetric outflow may be at least 2, 5, 10, 15, 20, or 25% of the influent volumetric inflow. In some embodiments, the sludge volumetric outflow may be less than or equal to 30, 25, 20, 15, 10, or 5% of the influent volumetric inflow. Combinations of these values are also possible, for example, at least 5% and less than or equal to 10% of the influent volumetric inflow.

In some embodiments, the sludge volumetric outflow may be at least 750, 1,500, 5,000, 10,000, 25,000, 50,000, 100,000, or 500,000 gallons per day. In some embodiments, the sludge volumetric outflow may be less than or equal to 1,000,000, 500,000, 150,000, 100,000, 50,000, 25,000, 10,000, 5,000, or 1,500 gallons per day. Combinations of these values are also possible, for example, at least 25,000 gallons per day and less than or equal to 50,000 gallons per day.

In some embodiments, the system may have a particular solids outflow through the sludge outlet. In some embodiments, the solids outflow may be at least 300, 1,000, 5,000, 10,000, 15,000, 20,000, 25,000, 30,000, 50,000, 100,000, 200,000, or 300,000 pounds per day. In some embodiments, the solids outflow may be less than or equal to 500,000, 300,000, 200,000, 100,000, 50,000, 30,000, 25,000, 20,000, 15,000, 10,000, 5,000, or 1,000 pounds per day. Combinations of these values are also possible, for example, at least 10,000 pounds per day and less than or equal to 25,000 pounds per day.

The clarifier may comprise a variety of shapes. The clarifier may have a rectangular, shoebox shape. The clarifier may comprise a flat bottom. The thickening portion of a clarifier may also take alternative shapes such as having a v-shaped bottom (e.g., v-shaped when viewing from a side view), a saw-toothed bottom, or a coned bottom. Different configurations may aid in enhancing compaction or providing a more uniform sludge blanket. FIG. 1 shows an example of a disclosed clarifier 100 comprising a flat bottom 105.

The clarifier may be designed to remain at a fixed location over the course of its operational life. Alternatively, the clarifier may be a mobile clarifier, sized and designed to be transported to a worksite where it is operated for the duration of a water treatment project.

In certain embodiments, the clarifier may have a specific volumetric capacity. In some embodiments, the clarifier may be sized to produce a desired average residence time for a given influent flow rate. Residence time is calculated by dividing the influent flow rate by the volume of the clarifier. In some embodiments, the clarifier may be sized to produce an average residence time of at least 5, 10, 15, 20, 25, 30, or 40 minutes. In some embodiments, the clarifier may be sized to produce an average residence time of less than or equal to 50, 40, 30, 25, 20, 15, or 10 minutes. Combinations of the above values are also possible, for example, at least 15 minutes and less than or equal to 20 minutes.

The second outlet, or sludge outlet, may be in fluidic communication with a sludge dewatering apparatus downstream of the clarifier. In the sludge dewatering apparatus, the sludge removed from the clarifier may undergo additional dewatering. Dewatering or drying of sludge generally reduces the volume of sludge that is to be disposed of, thereby reducing the handling and disposal costs. The sludge dewatering apparatus may selected from one or more of several technologies such as a belt filter press, plate and frame filter press, or a solid bowl decanter centrifuge. Other apparatuses may also be used for dewatering or thickening as would be understood by a person of ordinary skill in the art. According to some embodiments, the sludge dewatering apparatus is configured to produce a substantially solid cake.

According to some embodiments, a sludge holding tank is positioned downstream of the clarifier sludge outlet. According to some embodiments the second outlet is in fluidic communication with a sludge holding tank fluidically positioned between the clarifier and the sludge dewatering apparatus. While in some embodiments, sludge can be conveyed by pumping (e.g., directly pumping) to any of the types of dewatering equipment named above, if for any reason a shutdown of the sludge dewatering apparatus is required, underflow from the clarifier generally should be stopped. If underflow is stopped, the entire treatment plant and process influent flow to it may also be ceased or solids in the clarifier may rise, impairing the operation of the clarifier. According to some embodiments, the incorporation of a sludge holding tank provides a buffer between the clarifier underflow and the dewatering equipment, where depending on the volume of the sludge tank, storage capacity allows underflow to continue to be pumped from the clarifier to the sludge tank for a period of time while the dewatering equipment is not receiving new sludge. When the dewatering equipment is put back online, sludge pumps from the sludge tank to the dewatering equipment may be re-started again. Operational flexibility to deal with any number of scenarios may be provided by a sludge holding tank.

According to some embodiments, the sludge delivered to the sludge holding tank may be further thickened while in the sludge holding tank prior to its eventual transfer to a sludge dewatering apparatus. The sludge holding tanks may be fitted with motorized thickeners, in either a cone bottom or flat bottom holding tank design. Sludge tank thickeners in the sludge holding tank may achieve even greater thickening, for example, from 2% solids in the clarifier to 5% solids in the sludge buffer and thickening tank. Thickeners in the sludge tank can be of varying configurations such as “picket fence” style, to a scraper style more commonly found in flat bottom tanks. Picket fence thickeners promote settlement of sludge particles and homogenization of sludge by the creation of vertical passageways through the sludge mass permitting the upward movement of separated water and trapped air pockets. Other alternative devices for thickening include vibration/sonication, paddle wheels, and propeller mixers. Of these, picket fences, paddle wheels and propellers may be mounted on horizontally or vertically oriented shafts. Scrapers, rakes, as well as picket fences, may be mounted on booms rotating about a central shaft. Scrapers and rakes may be attached to a continuous track system that pulls them along the bottom of the tank. In some embodiments, a cone bottom arrangement can enhance thickening. The sludge holding tank may be fitted with one or more supernatant outlets, and in some embodiments, supernatant may be recycled back to an earlier stage in the waste treatment system, further reducing downstream dewatering equipment load and capacity.

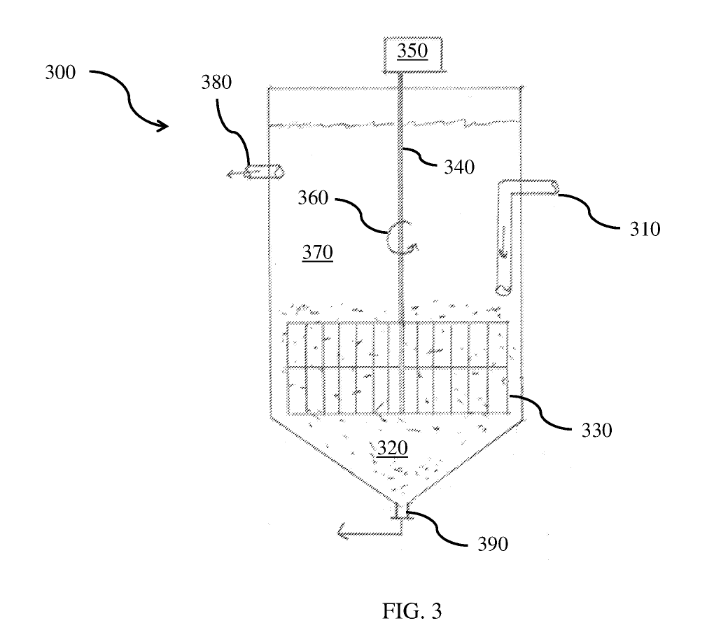

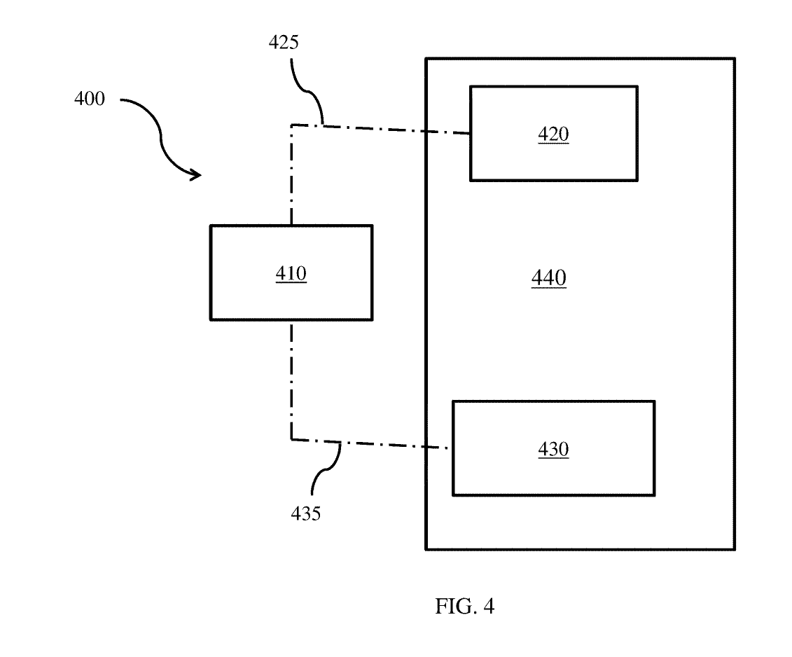

For example, FIG. 3 shows a representative sludge holding tank 300. In the holding tank 300, a stream from the sludge outlet of a clarifier is received, directly or indirectly, at inlet 310. In the embodiment shown in FIG. 3, sludge is thickened with a picket fence thickener 330, although it would be understood by a person of ordinary skill in the art that a different type of thickening apparatus could be used. The thickener 330 is coupled to a rotatable shaft 340 powered by a motor 350. The rotation of the thickener 330 and the shaft 340 is shown by rotational arrow 360. According to some embodiments, the shaft 340 is rotated at a rate of 1-3 RPM although other rotational speeds could be used, as would be understood by a person of ordinary skill in the art. A liquid portion 370 separated from the sludge portion 320 exits the sludge holding tank 300 through supernatant outlet 380. A thickened sludge exits the tank 300 through a sludge outlet 390, drawn by a pump (not shown in FIG. 3), where the sludge may be directed to further dewatering equipment. While the tank 300 shown in FIG. 4 has a cone-shaped bottom, alternative shapes could be used, as would be understood by a person of ordinary skill in the art.

According to certain embodiments, a control system may be incorporated into the water treatment system to improve the operation of the clarifier and other system components. The control system may comprise a controller, at least one input device (e.g., a sensor), and at least one output device (e.g., a pump). The controller may be configured to receive an input signal from the input device and to deliver an output signal, in response to the input signal, to the output device. For example, in certain embodiments, the clarifier may be coupled to a controller configured to receive an input signal from a sensor monitoring a depth of a sludge blanket in the clarifier, and to deliver an output signal, in response to the input signal, to a pump controlling a flow rate through the second outlet.

For example, FIG. 4 shows a representative control system 400. The control system 400 comprises a controller 410, an input device 420, and an output device 430 coupled together. The controller 410 may receive an input signal 425 from the input device 420 corresponding to a measurement taken by the input device 420. In response to the input signal 425, the controller 410 may deliver an output signal 435 to the output device 430 directing the operation of the output device. In FIG. 4, a clarifier 450 is coupled to the controller 410, so that the controller 410 aids in operations related to the clarifier 450.

The input device 420 may comprise a sensor or monitor. The input device may comprise a sensor configured to monitor a parameter of the clarifier 440. The input device 420 may be placed within or in proximity to the clarifier 450. For example, the input device 420 may comprise an ultrasonic measurement instrument calibrated to indicate the sludge blanket level within the clarifier. The input device may regularly or continuously transmit the level value to the controller via the input signal 425. In FIG. 1, an ultrasonic measurement instrument 170 is shown positioned in the clarifier 100 and delivers monitoring data to a controller (not shown in FIG. 1).

The output device 430 may comprise a device that affects a system parameter. For example, the output device 430 may comprise a pump or pumping system in fluidic communication with a sludge outlet from the clarifier. The output device may be controlled by the controller 410 via output signal 435. In FIG. 1, a pump 140 is shown positioned downstream of the sludge outlet 135.

According to some embodiments, the controller comprises a PID controller that operates according to a proportional-integral-derivative control loop. However, other control loop feedback mechanisms may be used, as would be understood by a person of ordinary skill in the art. Further description of components and aspects of a control system are described further below.

According to certain embodiments, the control system 300 may be operated to automatically monitor the sludge blanket level, and control the evacuation rate of the solids to maintain a constant sludge blanket level. The controller may be programmed to adjust the speed of the sludge pumping system via a control loop, thereby maintaining a constant sludge level, and maximizing thickening. Utilizing both the sludge level monitoring instrument together with the rotating protrusions provides improved solids thickening both by compaction as well as simultaneous agitation continuously releasing free water. According to certain embodiments, a steady state operating state may be maintained through control of the pump flow rate of solids through the outlet, without changing the rotational rate of the protrusions extending from the shaft, and without changing the feed flow rate into the clarifier through the inlet. Alternatively, aspects of the system other than or in addition to the pump may be controlled by the control system.

According to some embodiments, it is desirable to thicken sludge within the clarifier thickening region to the greatest extent possible prior to being evacuated by pumping for additional treatment downstream. Sludge handling and de-watering equipment, as well as operational costs are reduced proportionally to the increase in thickened sludge.

As discussed in the previous section, monitoring of the clarifier sludge blanket level improves the operation and/or efficiency of the system. As previously discussed, maximum retention time of the sludge in the clarifier enhances thickening, thereby reducing the pumped underflow volume of sludge, which results in downstream sludge dewatering equipment of a reduced capacity and cost.

According to some embodiments, proper control allows the top of the sludge blanket level (i.e., the solids/water interface) to be maintained at the rotatable shaft centerline. Maintenance of this sludge level aids in keeping the clarifier basin quiescent and the velocity of water flow in the clarifier basin below a velocity that would encourage undesired sludge scouring or jetting, while maximizing gravity thickening of the solids. Maintenance of a constant level of the solids/water interface facilitates achievement of both the minimum underflow rate and maximum solids concentration of the underflow.

According to certain embodiments, the disclosed clarifier may be operated to increase the thickening of sludge discharged through a sludge outlet (e.g., increasing the percent solids of the stream exiting the sludge outlet). According to certain embodiments, a method of operating a clarifier for a water treatment system may comprise separating, within a separator region of the clarifier, at least a portion of suspended solids from an aqueous inlet stream. The step of separating may produce a first product enriched in water relative to the aqueous inlet stream, the first product directed to a first outlet of the clarifier, and a second product positioned below the separator region of the clarifier. The second product may be enriched in solids relative to the aqueous inlet stream.

According to one or more embodiments, the second product may have a solids content of 2% by weight or greater and be directed to a second outlet (e.g., a sludge outlet) of the clarifier. According to one or more embodiments, the second product may have a solids content of 1% by weight or greater, 1.5% by weight or greater, 2% by weight or greater, 2.5% by weight or greater, 3% by weight or greater, 3.5% by weight or greater, 4% by weight or greater, 4.5% by weight or greater, or 5% by weight or greater. Other values are also possible.

According to one or more embodiments, the second product may be enriched in suspended solids relative to the aqueous inlet stream such that the ratio of a mass percentage of the solids in the second product to a mass percentage of solids in the inlet stream is at least about 20 to 1. According to one or more embodiments, ratio of mass percentages may be at least 10 to 1, at least 15 to 1, at least 20 to 1, at least 25 to 1, at least 30 to 1, at least 35 to 1, at least 40 to 1, at least 45 to 1, or at least 50 to 1. Other values are also possible.

With respect to the clarifier 100 shown in FIG. 1, components such as the rotatable shaft 150 with protrusions 145A and 145B facilitate the increased percentage of solids in the product exiting through the sludge outlet 135. The use of a sensor 170 for monitoring the depth of the sludge blanket 165 also facilitates increased thickening, by maximizing the amount of compaction by gravity.

According to one or more embodiments, the product enriched in suspended solids (e.g., thickened sludge) may be directed from the outlet of the clarifier directly to a sludge dewatering apparatus for further thickening or dewatering, without undergoing any intervening thickening or storage.

According to one or more embodiments, the product enriched in suspended solids (e.g., thickened sludge) may be directed to a sludge holding tank in fluidic communication with the sludge outlet from the clarifier and fluidically positioned between the clarifier and the sludge dewatering device. The sludge holding tank may receive the product enriched in suspended solids and further thicken the product to produce a third product further enriched in suspended solids compared to the product received from the clarifier. The third product may have a solids content of 4% by weight or greater and be directed to an outlet (e.g., a sludge outlet) of the sludge holding tank. According to one or more embodiments, the second product may have a solids content of 3% by weight or greater, 3.5% by weight or greater, 4% by weight or greater, 4.5% by weight or greater, 5% by weight or greater, 5.5% by weight or greater, 6% by weight or greater, 6.5% by weight or greater, or 7% by weight or greater. Other values are also possible.

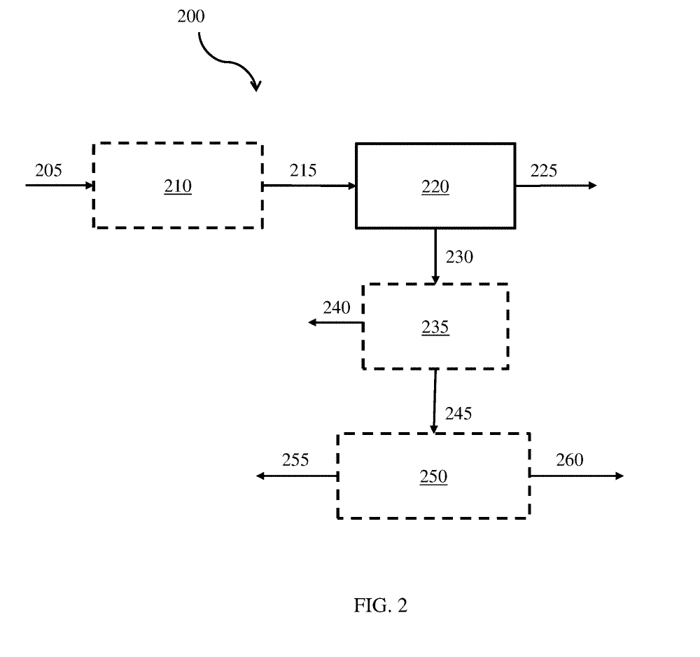

Embodiments of the clarifier disclosed herein may be used in a wide array of applications and incorporated into a variety of water treatment systems. The clarifier may be fluidically connected to one or more other unit operations of the water treatment system, either directly or indirectly. For example, FIG. 2 shows a water treatment system 200 comprising optional streams and components, into which a clarifier 220 is incorporated.

According to one embodiment of water treatment system 200, a raw water source 205 is directed to one or more pretreatment operations 210 to produce a pre-treated stream 215. The pre-treated stream is directed to the clarifier 220. The clarifier 220 produces at least two outlet streams. A first outlet stream 225 comprises a first product enriched in water relative to the aqueous inlet stream 215 and that has a reduced solids content compared to the inlet stream 215. A second outlet stream 230 from the clarifier 220 comprises a second product enriched in suspended solids relative to the aqueous inlet stream 215. The second product 230, or sludge product, may be optionally directed to a holding tank 235 where it may undergo further thickening to produce a water stream 240 and a thickened sludge stream 245. The thickened sludge stream 245 may then undergo one or more further sludge thickening and/or dewatering operations 250. The one or more operations 250 produce a water stream 255 and a thickened or dewatered product 260 (e.g., solid cake).

Various of the unit operations described herein can be “directly fluidically connected” to other unit operations and/or components. Generally, a direct fluid connection exists between a first unit operation and a second unit operation (and the two unit operations are said to be “directly fluidically connected” to each other) when they are fluidically connected to each other and the composition of the fluid does not substantially change (i.e., no fluid component changes in relative abundance by more than 5% and no phase change occurs) as it is transported from the first unit operation to the second unit operation. As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations.

It should also be understood that, where separate units are shown in the figures and/or described as performing a sequence of certain functions, the units may also be present as a single unit (e.g., within a common housing), and the single unit may perform a combination of functions.

It should also be understood that a number of different unit operations, not shown in any of the figures, may be performed at various stages of the system either upstream of one or more inlets to the clarifier or downstream of one or more outlets from the clarifier. Unit operations that may form part of the water treatment system include, without limitation, ion removal apparatuses, pH reduction apparatuses, electrocoagulation apparatuses, desalination apparatuses, precipitation apparatuses, and VOM (volitale organic matter) removal apparatuses. These and other unit operations are described in more detail in U.S. Patent Application Publication No. 2015/0060286, filed on Aug. 5, 2015 and entitled “Water Treatment Systems and Associated Methods,” which is incorporated herein by reference in its entirety for all purposes.

The water delivered to the clarifier or optional pretreatment operations may come from a variety of sources. In some embodiments, the water may be oilfield wastewater.

In some embodiments, an aqueous input stream (e.g., a stream delivered to a clarifier before, after, or without undergoing pretreatment) may comprise at least one suspended and/or emulsified immiscible phase (e.g., oil, grease) and, in some cases, one or more additional contaminants, such as solubilized bicarbonate (HCO³⁻) ions, solubilized divalent cations (e.g., Ca²⁺, Mg²⁺), solubilized trivalent cations (e.g., Fe³⁺, Al³⁺), organic material (e.g., humic acid, fulvic acid), hydrogen sulfide (H₂S), and/or suspended solids.

According to some embodiments, the aqueous input stream comprises and/or is derived from produced water and/or flowback water. In some embodiments, the aqueous input stream comprises at least one suspended and/or emulsified immiscible phase (e.g., oil, grease). In certain cases, the aqueous input stream further comprises one or more additional contaminants. The one or more additional contaminants may include, but are not limited to, solubilized bicarbonate (HCO³⁻) ions, solubilized divalent cations (e.g., Ca²⁺, Mg²⁺), solubilized trivalent cations (e.g., Fe³⁺, Al³⁺), organic material (e.g., humic acid, fulvic acid), hydrogen sulfide (H₂S), and suspended solids.

In some embodiments, the aqueous input stream comprises at least one suspended and/or emulsified immiscible phase. As used herein, a suspended and/or emulsified immiscible phase (e.g., a water-immiscible material) refers to a material that is not soluble in water to a level of more than 10% by weight at the temperature and under the conditions at which the chemical coagulation apparatus operates. In some embodiments, the suspended and/or emulsified immiscible phase comprises oil and/or grease. As used herein, the term “oil” refers to a fluid that is generally more hydrophobic than water and is not miscible or soluble in water, as is known in the art. Thus, the oil may be a hydrocarbon in some embodiments, but in other embodiments, the oil may comprise other hydrophobic fluids.

In some embodiments, the aqueous input stream has a relatively high concentration of at least one suspended and/or emulsified immiscible phase. In some embodiments, the aqueous input stream has a concentration of at least one suspended and/or emulsified immiscible phase of at least about 50 mg/L, at least about 75 mg/L, at least about 100 mg/L, at least about 125 mg/L, at least about 150 mg/L, at least about 175 mg/L, at least about 200 mg/L, at least about 250 mg/L, at least about 300 mg/L, at least about 350 mg/L, at least about 400 mg/L, at least about 450 mg/L, or at least about 500 mg/L. In some embodiments, the aqueous input stream has a concentration of at least one suspended and/or emulsified immiscible phase in the range of about 50 mg/L to about 100 mg/L, about 50 mg/L to about 150 mg/L, about 50 mg/L to about 200 mg/L, about 50 mg/L to about 250 mg/L, about 50 mg/L to about 300 mg/L, about 50 mg/L to about 350 mg/L, about 50 mg/L to about 400 mg/L, about 50 mg/L to about 450 mg/L, about 50 mg/L to about 500 mg/L, about 100 mg/L to about 150 mg/L, about 100 mg/L to about 200 mg/L, about 100 mg/L to about 250 mg/L, about 100 mg/L to about 300 mg/L, about 100 mg/L to about 350 mg/L, about 100 mg/L to about 400 mg/L, about 100 mg/L to about 450 mg/L, about 100 mg/L to about 500 mg/L, about 150 mg/L to about 200 mg/L, about 150 mg/L to about 250 mg/L, about 150 mg/L to about 300 mg/L, about 150 mg/L to about 350 mg/L, about 150 mg/L to about 400 mg/L, about 150 mg/L to about 450 mg/L, about 150 mg/L to about 500 mg/L, about 200 mg/L to about 300 mg/L, about 200 mg/L to about 350 mg/L, about 200 mg/L to about 400 mg/L, about 200 mg/L to about 450 mg/L, about 200 mg/L to about 500 mg/L, about 300 mg/L to about 400 mg/L, about 300 mg/L to about 500 mg/L, or about 400 mg/L to about 500 mg/L. One suitable method of measuring the concentration of a suspended and/or emulsified immiscible phase is using a Total Organic Carbon analyzer.

In some embodiments, the aqueous input stream comprises one or more dissolved salts. A dissolved salt is a salt that has been solubilized to such an extent that the component ions of the salt are no longer ionically bonded to each other. Accordingly, the aqueous input stream may comprise one or more solubilized ions.

In some embodiments, the one or more solubilized ions comprise solubilized monovalent cations (i.e., cations with a redox state of +1). Non-limiting examples of monovalent cations include Na⁺, K⁺, Li⁺, Rb⁺, Cs⁺, Fr⁺. In some embodiments, the one or more solubilized ions comprise divalent cations (e.g., cations with a redox state of +2). Examples of divalent cations include, but are not limited to, Ca²⁺, Mg²⁺, Ba²⁺, and Sr²⁺. In some embodiments, the one or more solubilized cations comprise trivalent cations (i.e., cations with a redox state of +3). Non-limiting examples of trivalent cations include Fe³⁺ and Al³⁺. In some embodiments, the one or more solubilized ions comprise tetravalent cations (i.e., cations with a redox state of +4).

In some embodiments, the one or more solubilized ions include solubilized monovalent anions (i.e., anions with a redox state of −1). Non-limiting examples of monovalent anions include Cl⁻, Br⁻, and HCO³⁻. In some embodiments, the one or more solubilized ions include solubilized divalent anions (i.e., anions with a redox state of −2). Non-limiting examples of divalent anions include SO₄²⁻ and CO₃²⁻.

In some embodiments, the aqueous input stream has a relatively high concentration of solubilized bicarbonate anions. In some embodiments, the bicarbonate ion concentration of the aqueous input stream is at least about 50 mg/L, at least about 100 mg/L, at least about 200 mg/L, at least about 300 mg/L, at least about 400 mg/L, at least about 500 mg/L, at least about 550 mg/L, at least about 600 mg/L, at least about 650 mg/L, at least about 700 mg/L, at least about 800 mg/L, at least about 900 mg/L, at least about 1000 mg/L, at least about 1500 mg/L, or at least about 2000 mg/L. In some embodiments, the bicarbonate ion concentration of the aqueous input stream is in the range of about 50 mg/L to about 100 mg/L, about 50 mg/L to about 200 mg/L, about 50 mg/L to about 300 mg/L, about 50 mg/L to about 400 mg/L, about 50 mg/L to about 500 mg/L, about 50 mg/L to about 600 mg/L, about 50 mg/L to about 700 mg/L, about 50 mg/L to about 800 mg/L, about 50 mg/L to about 900 mg/L, about 50 mg/L to about 1000 mg/L, about 50 mg/L to about 1500 mg/L, about 50 mg/L to about 2000 mg/L, about 100 mg/L to about 200 mg/L, about 100 mg/L to about 300 mg/L, about 100 mg/L to about 400 mg/L, about 100 mg/L to about 500 mg/L, about 100 mg/L to about 600 mg/L, about 100 mg/L to about 700 mg/L, about 100 mg/L to about 800 mg/L, about 100 mg/L to about 900 mg/L, about 100 mg/L to about 1000 mg/L, about 100 mg/L to about 1500 mg/L, about 100 mg/L to about 2000 mg/L, about 200 mg/L to about 300 mg/L, about 200 mg/L to about 400 mg/L, about 200 mg/L to about 500 mg/L, about 200 mg/L to about 600 mg/L, about 200 mg/L to about 700 mg/L, about 200 mg/L to about 800 mg/L, about 200 mg/L to about 900 mg/L, about 200 mg/L to about 1000 mg/L, about 200 mg/L to about 1500 mg/L, about 200 mg/L to about 2000 mg/L, about 300 mg/L to about 2000 mg/L, about 400 mg/L to about 2000 mg/L, about 500 mg/L to about 2000 mg/L, about 600 mg/L to about 2000 mg/L, about 700 mg/L to about 2000 mg/L, about 800 mg/L to about 2000 mg/L, about 900 mg/L to about 2000 mg/L, about 1000 mg/L to about 2000 mg/L, or about 1500 mg/L to about 2000 mg/L. The bicarbonate ion concentration is a property of the solution that may be determined according to any appropriate method known in the art, including ICP spectroscopy.

In some embodiments, the aqueous input stream has a relatively high concentration of solubilized divalent cations (which may be collectively referred to as “hardness”). In some embodiments, the concentration of solubilized divalent cations in the aqueous input stream is at least about 500 mg/L, at least about 1000 mg/L, at least about 1500 mg/L, at least about 2000 mg/L, at least about 2500 mg/L, at least about 3000 mg/L, at least about 3500 mg/L, at least about 4000 mg/L, at least about 4500 mg/L, or at least about 5000 mg/L. In some embodiments, the concentration of solubilized divalent cations in the aqueous input stream is in the range of about 500 mg/L to about 1000 mg/L, about 500 mg/L to about 1500 mg/L, about 500 mg/L to about 2000 mg/L, about 500 mg/L to about 2500 mg/L, about 500 mg/L to about 3000 mg/L, about 500 mg/L to about 3500 mg/L, about 500 mg/L to about 4000 mg/L, about 500 mg/L to about 4500 mg/L, about 500 mg/L to about 5000 mg/L, about 1000 mg/L to about 1500 mg/L, about 1000 mg/L to about 2000 mg/L, about 1000 mg/L to about 2500 mg/L, about 1000 mg/L to about 3000 mg/L, about 1000 mg/L to about 3500 mg/L, about 1000 mg/L to about 4000 mg/L, about 1000 mg/L to about 4500 mg/L, about 1000 mg/L to about 5000 mg/L, about 2000 mg/L to about 2500 mg/L, about 2000 mg/L to about 3000 mg/L, about 2000 mg/L to about 3500 mg/L, about 2000 mg/L to about 4000 mg/L, about 2000 mg/L to about 4500 mg/L, about 2000 mg/L to about 5000 mg/L, about 3000 mg/L to about 3500 mg/L, about 3000 mg/L to about 4000 mg/L, about 3000 mg/L to about 4500 mg/L, about 3000 mg/L to about 5000 mg/L, or about 4000 mg/L to about 5000 mg/L. The divalent ion concentration is a property of the solution that may be determined according to any appropriate method known in the art, including ICP spectroscopy.

In some embodiments, the aqueous input stream has a relatively high total dissolved salt concentration. In some embodiments, the aqueous input stream has a total dissolved salt concentration of at least about 50,000 mg/L, at least about 75,000 mg/L, at least about 100,000 mg/L, at least about 125,000 mg/L, at least about 150,000 mg/L, at least about 175,000 mg/L, or at least about 200,000 mg/L. In some embodiments, the aqueous input stream has a total dissolved salt concentration in the range of about 50,000 mg/L to about 75,000 mg/L, about 50,000 mg/L to about 100,000 mg/L, about 50,000 mg/L to about 125,000 mg/L, about 50,000 mg/L to about 150,000 mg/L, about 50,000 mg/L to about 175,000 mg/L, about 50,000 mg/L to about 200,000 mg/L, about 100,000 mg/L to about 125,000 mg/L, about 100,000 mg/L to about 150,000 mg/L, about 100,000 mg/L to about 175,000 mg/L, or about 100,000 mg/L to about 200,000 mg/L. The total dissolved salt concentration generally refers to the combined concentrations of all the cations and anions of dissolved salts that are present. As a simple, non-limiting example, in a water stream comprising dissolved NaCl and dissolved MgSO₄, the total dissolved salt concentration would refer to the total concentrations of the Na⁺, Cl⁻, Mg₂⁺, and SO₄²⁻ ions. Total dissolved salt concentration is a solution property that may be measured according to any appropriate method known in the art. For example, a suitable method for measuring total dissolved salt concentration is the SM 2540C method. According to the SM 2540C method, a sample comprising an amount of liquid comprising one or more dissolved solids is filtered (e.g., through a glass fiber filter), and the filtrate is evaporated to dryness in a weighed dish at 180° C. The increase in dish weight represents the mass of the total dissolved solids in the sample. The total dissolved salt concentration of the sample may be obtained by dividing the mass of the total dissolved solids by the volume of the original sample.

In some embodiments, the aqueous input stream has a relatively high total suspended solids concentration. The total suspended solids concentration of an aqueous stream as used herein refers to the total mass of solids retained by a filter per unit volume of the aqueous stream as measured using the SM 2540 D method. In some embodiments, the aqueous input stream has a total suspended solids concentration of at least about 500 mg/L, at least about 1000 mg/L, at least about 1500 mg/L, at least about 2000 mg/L, at least about 2500 mg/L, at least about 3000 mg/L, at least about 3500 mg/L, at least about 4000 mg/L, at least about 4500 mg/L, or at least about 5000 mg/L. In some embodiments, the total suspended solids concentration of the aqueous input stream is in the range of about 500 mg/L to about 1000 mg/L, about 500 mg/L to about 1500 mg/L, about 500 mg/L to about 2000 mg/L, about 500 mg/L to about 2500 mg/L, about 500 mg/L to about 3000 mg/L, about 500 mg/L to about 3500 mg/L, about 500 mg/L to about 4000 mg/L, about 500 mg/L to about 4500 mg/L, about 500 mg/L to about 5000 mg/L, about 1000 mg/L to about 1500 mg/L, about 1000 mg/L to about 2000 mg/L, about 1000 mg/L to about 2500 mg/L, about 1000 mg/L to about 3000 mg/L, about 1000 mg/L to about 3500 mg/L, about 1000 mg/L to about 4000 mg/L, about 1000 mg/L to about 4500 mg/L, about 1000 mg/L to about 5000 mg/L, about 2000 mg/L to about 2500 mg/L, about 2000 mg/L to about 3000 mg/L, about 2000 mg/L to about 3500 mg/L, about 2000 mg/L to about 4000 mg/L, about 2000 mg/L to about 4500 mg/L, about 2000 mg/L to about 5000 mg/L, about 3000 mg/L to about 3500 mg/L, about 3000 mg/L to about 4000 mg/L, about 3000 mg/L to about 4500 mg/L, about 3000 mg/L to about 5000 mg/L, or about 4000 mg/L to about 5000 mg/L.

In some embodiments, the aqueous input stream comprises hydrogen sulfide (H2S). In certain cases, for example, hydrogen sulfide may be produced by certain kinds of bacteria (e.g., sulfate-reducing bacteria). In some embodiments, the concentration of hydrogen sulfide in the aqueous input stream is at least about 10 mg/L, at least about 20 mg/L, at least about 30 mg/L, at least about 40 mg/L, at least about 50 mg/L, or at least about 100 mg/L. In some embodiments, the hydrogen sulfide concentration of the aqueous input stream is in the range of about 10 mg/L to about 100 mg/L, about 20 mg/L to about 100 mg/L, about 30 mg/L to about 100 mg/L, about 40 mg/L to about 100 mg/L, or about 50 mg/L to about 100 mg/L.

In some embodiments, the aqueous input stream comprises organic matter (e.g., dissolved organic matter). In some cases, for example, the aqueous input stream comprises humic acid and/or fulvic acid. One measure of the amount of organic matter, including humic acid and/or fulvic acid, in an aqueous stream is the Pt—Co color value of the aqueous stream. In some embodiments, the aqueous input stream has a Pt—Co color value of at least about 100, at least about 250, at least about 500, at least about 750, at least about 1000, at least about 1250, or at least about 1500. In some embodiments, the aqueous input stream has a Pt—Co color value in the range of about 100 to about 1500, about 250 to about 1500, about 500 to about 1500, about 750 to about 1500, about 1000 to about 1500, or about 1250 to about 1500. The Pt—Co color value as used herein is determined according to ASTM Designation 1209, “Standard Test Method for Color of Clear Liquids (Platinum-Cobalt Scale).”

According to certain embodiments, pretreating water may comprise supplying an aqueous input stream comprising at least one suspended and/or emulsified immiscible phase to a chemical coagulation apparatus. Within the chemical coagulation apparatus, an amount of an inorganic coagulant (e.g., aluminum chlorohydrate, polyaluminum chloride), an amount of a strong base (e.g., sodium hydroxide), and an amount of a polyelectrolyte (e.g., anionic polyacrylamide) may be added to the aqueous input stream to form a chemically-treated stream. In some embodiments, the inorganic coagulant, strong base, and/or polyelectrolyte may induce coagulation and/or flocculation of at least a portion of the contaminants within the aqueous input stream, and the chemically-treated stream may comprise a plurality of flocs (i.e., particle agglomerates).

Those of ordinary skill in the art are capable of determining the residence time of a volume of fluid in a vessel. For a batch (i.e., non-flow) system, the residence time corresponds to the amount of time the fluid spends in the vessel. For a flow-based system, the residence time is determined by dividing the volume of the vessel by the volumetric flow rate of the fluid through the vessel.

In some embodiments, the residence time of a stream in the clarifier may have a certain value. In certain embodiments, the residence time of a stream in the clarifier is about 1 hour or less, about 45 minutes or less, about 30 minutes or less, about 15 minutes or less, or about 10 minutes or less. In some embodiments, the residence time of a stream in the clarifier is in the range of about 10 minutes to about 15 minutes, about 10 minutes to about 20 minutes, about 10 minutes to about 30 minutes, about 10 minutes to about 45 minutes, or about 10 minutes to about 1 hour.

In some embodiments, the clarifier can produce a water-containing stream that contains a lower concentration of suspended solids than the stream fed to the clarifier. For example, in FIG. 2, the clarifier 220 can be configured to produce water-containing stream 225, which contains less suspended solids than the streams 205 or 215 fed to the clarifier 220.

In some embodiments, the clarifier is configured to produce an effluent stream containing water of relatively high purity. For example, in some embodiments, the clarifier produces an effluent stream (e.g., the water-enriched stream 225 in FIG. 2) containing water in an amount of at least about 95 wt %, at least about 99 wt %, at least about 99.9 wt %, or at least about 99.99 wt % (and/or, in certain embodiments, up to about 99.999 wt %, or more).

According to some embodiments, the water-enriched stream has a relatively low concentration of the suspended solids. In certain embodiments, the c water-enriched stream has a concentration of suspended solids of about 100 mg/L or less, about 90 mg/L or less, about 80 mg/L or less, about 70 mg/L or less, about 60 mg/L or less, about 50 mg/L or less, about 40 mg/L or less, about 30 mg/L or less, about 20 mg/L or less, about 15 mg/L or less, about 10 mg/L or less, about 5 mg/L or less, or about 1 mg/L or less. In some embodiments, the contaminant-diminished stream has a concentration of suspended solids in the range of about 0 mg/L to about 100 mg/L, about 0 mg/L to about 90 mg/L, about 0 mg/L to about 80 mg/L, about 0 mg/L to about 70 mg/L, about 0 mg/L to about 60 mg/L, about 0 mg/L to about 50 mg/L, about 0 mg/L to about 40 mg/L, about 0 mg/L to about 30 mg/L, about 0 mg/L to about 20 mg/L, about 0 mg/L to about 15 mg/L, about 0 mg/L to about 10 mg/L, about 0 mg/L to about 5 mg/L, or about 0 mg/L to about 1 mg/L. In some embodiments, the water-enriched stream is substantially free of suspended solids.

According to some embodiments, the clarifier produces a certain amount of sludge per barrel of clarified effluent. In some embodiments, the amount of sludge per barrel of clarified effluent is at least 2, 6, 10, 13, 20, 30, or 40 kg/bbl. In some embodiments the amount is less than or equal to 50, 40, 30, 20, 13, 10, 6, or 2 kg/bbl. Combinations of the above values are also possible, for example at least 6 kg/bbl and less than or equal to 13 kg/bbl.

According to certain embodiments, the water-containing stream that exits the clarifier and that contains a lower concentration of suspended solids than the stream fed to the clarifier can be transported, at least in part, to a desalination apparatus. For example, according to certain embodiments, a water treatment system comprises a clarifier (e.g., any of the clarifiers described herein) and a desalination apparatus. The water treatment system can also comprise any of the other system components described elsewhere herein. In some embodiments, the desalination apparatus can be used to produce a concentrated saline stream enriched in a dissolved salt (e.g., enriched in a dissolved monovalent salt) relative to the aqueous stream received by the desalination apparatus. The desalination apparatus can be used, according to some embodiments, to produce a water-containing stream that contains less of the dissolved salt (e.g., less of the dissolved monovalent salt) than the aqueous stream received by the desalination apparatus. Exemplary desalination apparatuses that may be used in the water treatment systems described herein include, but are not limited to, humidification/dehumidification desalination apparatuses, mechanical vapor compression desalination apparatuses), vacuum distillation desalination apparatuses, and/or hybrid systems comprising two or more of these. Desalination apparatuses suitable for use in association with certain of the embodiments described herein are described, for example, in U.S. Patent Application Publication No. 2015/0060286, published on Mar. 5, 2015, filed as U.S. Ser. No. 14/452,387 on Aug. 5, 2014, and entitled “Water Treatment Systems and Associated Methods”; U.S. Patent Application Publication No. 2015/0129410, published on May 14, 2015, filed as U.S. Ser. No. 14/485,606 on Sep. 12, 2014, and entitled “Systems Including a Condensing Apparatus such as a Bubble Column Condenser”; U.S. Patent Application Publication No. 2015/0083577, published on Mar. 26, 2015, filed as U.S. Ser. No. 14/494,101 on Sep. 23, 2014, and entitled “Desalination Systems and Associated Methods”; and U.S. Pat. No. 9,221,694, issued on Dec. 29, 2015, filed as U.S. Ser. No. 14/537,117 on Nov. 10, 2014, and entitled “Selective Scaling in Desalination Water Treatment Systems and Associated Methods”; each of which is incorporated herein by reference in its entirety for all purposes.

As described above, certain embodiments of the inventive systems include one or more computer implemented control systems for operating various components of the water treatment system, (e.g., controller 410 of the computer implemented control system 400 shown in FIG. 4). In general, any calculation methods, steps, simulations, algorithms, systems, and system elements described herein may be implemented and/or controlled using one or more computer implemented control system(s), such as the various embodiments of computer implemented systems described below. The methods, steps, control systems, and control system elements described herein are not limited in their implementation to any specific computer system described herein, as many other different machines may be used.

The computer implemented control system can be part of or coupled in operative association with a clarifier of a water treatment system and/or other automated system components, and, in some embodiments, is configured and/or programmed to control and adjust operational parameters, as well as analyze and calculate values, for example a sludge blanket level as described above. In some embodiments, the computer implemented control system(s) can send and receive reference signals to set and/or control operating parameters of system apparatus. In other embodiments, the computer implemented system(s) can be separate from and/or remotely located with respect to the other system components and may be configured to receive data from one or more systems of the invention via indirect and/or portable means, such as via portable electronic data storage devices, such as magnetic disks, or via communication over a computer network, such as the Internet or a local intranet.

The computer implemented control system(s) may include several known components and circuitry, including a processing unit (i.e., processor), a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) may be a multi-processor computer system or may include multiple computers connected over a computer network.

In typical industrial systems, the type of computer used may be a Programmable Logic Controller (PLC), for example, an Allen-Bradley ControlLogix 1756-L71. PLCs may run extremely stable operating systems designed for deterministic logic execution and contain hardware with high tolerance to temperature, humidity, and vibration.

In some embodiments, the ControlLogix 1756 runs VxWorks operating system, has a ControlLogix processor, and can be connected to over 100,000 digital inputs and outputs (I/O) and 4000 analog I/Os. PLCs generally utilize Ladder Logic programming.

In some embodiments, the PLC may run a proportional, integral, derivative (PID) control system. Input may come from the sludge blanket level instrument, and the controller may output a signal to the pump.

The computer implemented control system(s) may include a processor, for example, a commercially available processor such as one of the series x86, Celeron and Pentium processors, available from Intel, similar devices from AMD and Cyrix, the 680X0 series microprocessors available from Motorola, and the PowerPC microprocessor from IBM. Many other processors are available, and the computer system is not limited to a particular processor.

A processor typically executes a program called an operating system, of which WindowsNT, Windows 95 or 98, Windows XP, Windows Vista, Windows 7, UNIX, Linux, DOS, VMS, MacOS and OS8 are examples, which controls the execution of other computer programs and provides scheduling, debugging, input/output control, accounting, compilation, storage assignment, data management and memory management, communication control and related services. The processor and operating system together define a computer platform for which application programs in high-level programming languages are written. The computer implemented control system is not limited to a particular computer platform.

The computer implemented control system(s) may include a memory system, which typically includes a computer readable and writeable non-volatile recording medium, of which a magnetic disk, optical disk, a flash memory and tape are examples. Such a recording medium may be removable, for example, a floppy disk, read/write CD or memory stick, or may be permanent, for example, a hard drive.

Such a recording medium stores signals, typically in binary form (i.e., a form interpreted as a sequence of one and zeros). A disk (e.g., magnetic or optical) has a number of tracks, on which such signals may be stored, typically in binary form, i.e., a form interpreted as a sequence of ones and zeros. Such signals may define a software program, e.g., an application program, to be executed by the microprocessor, or information to be processed by the application program.

The memory system of the computer implemented control system(s) also may include an integrated circuit memory element, which typically is a volatile, random access memory such as a dynamic random access memory (DRAM) or static memory (SRAM). Typically, in operation, the processor causes programs and data to be read from the non-volatile recording medium into the integrated circuit memory element, which typically allows for faster access to the program instructions and data by the processor than does the non-volatile recording medium.

The processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer implemented control system(s) that implements the methods, steps, systems control and system elements control described above is not limited thereto. The computer implemented control system(s) is not limited to a particular memory system.

At least part of such a memory system described above may be used to store one or more data structures (e.g., look-up tables) or equations such as calibration curve equations. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer implemented control system(s) may include one or more output devices. Example output devices include a cathode ray tube (CRT) display, liquid crystal displays (LCD) and other video output devices, printers, communication devices such as a modem or network interface, storage devices such as disk or tape, and audio output devices such as a speaker.

The computer implemented control system(s) also may include one or more input devices. Example input devices include a keyboard, keypad, track ball, mouse, pen and tablet, communication devices such as described above, and data input devices such as audio and video capture devices and sensors. The computer implemented control system(s) is not limited to the particular input or output devices described herein.

It should be appreciated that one or more of any type of computer implemented control system may be used to implement various embodiments described herein. Aspects of the invention may be implemented in software, hardware or firmware, or any combination thereof. The computer implemented control system(s) may include specially programmed, special purpose hardware, for example, an application-specific integrated circuit (ASIC). Such special-purpose hardware may be configured to implement one or more of the methods, steps, simulations, algorithms, systems control, and system elements control described above as part of the computer implemented control system(s) described above or as an independent component.

The computer implemented control system(s) and components thereof may be programmable using any of a variety of one or more suitable computer programming languages. Such languages may include procedural programming languages, for example, LabView, C, Pascal, Fortran and BASIC, object-oriented languages, for example, C++, Java and Eiffel and other languages, such as a scripting language or even assembly language.

The methods, steps, simulations, algorithms, systems control, and system elements control may be implemented using any of a variety of suitable programming languages, including procedural programming languages, object-oriented programming languages, other languages and combinations thereof, which may be executed by such a computer system. Such methods, steps, simulations, algorithms, systems control, and system elements control can be implemented as separate modules of a computer program, or can be implemented individually as separate computer programs. Such modules and programs can be executed on separate computers.

Such methods, steps, simulations, algorithms, systems control, and system elements control, either individually or in combination, may be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product may comprise computer-readable signals tangibly embodied on the computer-readable medium that define instructions, for example, as part of one or more programs, that, as a result of being executed by a computer, instruct the computer to perform the method, step, simulation, algorithm, system control, or system element control.

The following examples are intended to illustrate certain embodiments of the present invention, but do not exemplify the full scope of the invention.

### Example 1

In this Example, a water treatment system comprising a solids handling system is described. This system was operated in the Permian Basin, recycling hydraulic fracturing wastewater. It comprised a suspended oil removal system, a precipitative softening system, a clarifier, a sludge dewatering system, a pH neutralization system, and a biocide feeding system.

During a 22 day period, the plant operated for 200 hours, treating 2.7 million gallons of wastewater and producing 80 cubic yards of dewatered solids. Averaged results of the influent and effluent water are shown in table 1 below. Each parameter was measured daily, and averaged results were weighted by production rates. The composition of the solids removed in the clarifier are shown in Table 3.

Prior to entering the clarifier, oil and grease were removed from the raw water in the oil removal system. Some dissolved solids were precipitated in the precipitated and flocculated in the precipitative softening system. Precipitation was caused by raising the pH of the water to 11 with the addition of sodium hydroxide. An anionic polymer was added to increase adhesion between solids and cause the formation of flocs. The chemicals added to the system and their dosages, were selected to promote good settling in the clarifier. Downstream of the clarifier, hydrochloric acid was added to neutralize the pH, and a biocide was added to reduce bacteria.

TABLE 1
Averaged Influent and Effluent Water Constituents

| Parameter | Weighted Monthly | Weighted Monthly |
|---|---|---|
| (bold indicates | Average Untreated | Average Treated |
| critical parameter) | Water Quality | Water Quality |
| Temperature [° F.] | 62.53 | 62.41 |
| pH [—] | 6.27 | 7.72 |
| Specific Gravity [—] | 1.15 | 1.15 |
| Bacteria (ATP) [pg/mL] | 3.24 | 0.37 |
| Iron [mg/L] | 17.86 | 5.45 |
| Chloride [mg/L] | 105,258.01 | 104,574.23 |
| Alkalinity (HCO₃⁻) [mg/L] | 346.63 | 505.70 |
| Total Hardness [mg/L] | 16,636.98 | 16,750.86 |
| Sulfate (SO₄⁻²) [mg/L] | 475.08 | 400.44 |
| Total dissolved solids [mg/L] | 168,734.85 | 167,804.20 |
| Turbidity [NTU] | 75.36 | 4.33 |
| Total Chlorine [mg/L] | 0.76 | 0.56 |
| Free Available Chlorine | 0.61 | 0.55 |
| [mg/L] | | |
| ORP [mg/L] | 296.61 | 272.71 |
| DO [mg/L] | 4.97 | 5.38 |
| H₂S [mg/L] | 0.22 | 0.00 |
| Total Suspended Solids | 105.98 | 29.36 |
| [mg/L] | | |
| Conductivity [μS/cm] | 210.61 | 210.35 |

The clarifier comprised two sections: a separation section containing parallel plate packs, and a thickening section containing a rotatable shaft with protrusions extending outwardly, also referred to as an agitator. Water, carrying an average of 0.1% suspended solids by weight, entered the clarifier at an average rate of 237 gpm. The influent water flowed upward through the parallel plate packs. The slow laminar flow in the plate packs allowed solids suspended in this stream to settle downwards and agglomerate on the upper faces of the plates. The settling characteristics of a clarifier are well described by the specifications listed in table 2 below.

TABLE 2
Clarifier Settling Specifications

| Specification | Value | |
|---|---|---|
| Vertical plate spacing | 2 | inches |
| Surface loading rate | .25 | gpm/ft² |
| Maximum influent flow rate | 450 | gpm |
| Specific gravity of solids | 2.81 | |
| Specific gravity of liquid | 1.07 | |
| Dynamic viscosity of liquid | 0.022 | lb · s/ft² |

Clarified water flowed out of the top of the plate packs where it was collected by a set of perforated gravity-draining launders. Excepting pH and bacteria parameters, the clarifier effluent is identical to the system effluent shown in Table 1.

The thickening section, positioned directly below the separation section, collected agglomerated solids sliding off the plate packs to form a “sludge blanket.” To those skilled in the art, this term describes the distinct boundary formed between dispersed settling particles, and particles that have come into contact with each other to form zones. The zones are separated by upwardly flowing water displaced by the settling solids. Because the zone settling is significantly slower than the free settling that occurs above it, a distinct boundary is observable between the two, characterized by substantial differences in solids concentrations. Zones of particles are compressed by the weight of additional particles above them, causing water to flow out of the zones and into the interstitial spaces. As compression continues, those interstitial spaces may become sealed off, preventing interstitial water from flowing upwards.

To free the trapped interstitial water, an agitator in the bottom of the clarifier slowly stirred the sludge blanket to bring trapped pockets of water to the surface. Additionally, the stirring homogenized the sludge, allowing it to flow evenly into the sludge outlet and discouraging the formation of rat holes and bridges. The agitator, like that shown in FIG. 1, comprised a longitudinal axil, and angled protrusions that passed through the surface of the sludge blanket. The angled faces of the protrusions directed sludge toward the center of the thickening basin where the sludge outlet is located, encouraging greater homogenization at this location. The rotational rate of this agitator was set to 3 revolutions per minute by a variable frequency drive, and powered by a 1 HP motor.

Two air operated diaphragm pumps removed sludge, thickened to an average solids concentration of 5% by weight, from the clarifier at an average flow rate of 12 gpm. The sludge was pumped to a 6900 gallon buffer tank, then pumped again to a filter press for dewatering. The resultant dewatered sludge was removed from the site and taken to a landfill for disposal. The composition of the dewatered sludge is shown in Table 3.

The bulk chemical composition by oxide presented in the table below was analyzed using an X-ray fluorescence method. This data was then corrected to remove the influence of dissolved solids on the results. In the analysis, the sludge sample was dried and heated to 1000° C. and mixed with a lithium borate flux to form a glass bead. The bead was analyzed using an Axios PANalytical XRF. Solids dissolved in the moisture content of the sludge were analyzed using an Optima 8300 ICP-OES spectrometer. Volatile liquid content of the sludge was measured by weight difference before and after 24 hours of drying at 60° C. Total dissolved solids in the moisture content were measured using the SM2540 C-97 method. The dissolved solid concentration of the liquid and the volatile liquid composition of the sludge were used to calculate share of each dissolved solid in the XRF results to yield the corrected solid composition below.

TABLE 3
Solids Composition

| Salt | salt/solids |
|---|---|
| NaCl | 7.38% |
| MgO | 2.91% |
| Al₂O₃ | 8.30% |
| SiO₂ | 2.91% |
| P₂O₅ | 0.15% |
| SO₃ | 5.30% |
| CaCO₃ | 65.87% |
| MnO | 0.14% |
| Fe₂O₃ | 4.89% |
| ZnO | 0.02% |
| Br | 0.14% |
| SrO | 2.04% |
| Total (% of solids) | 100.0% |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A clarifier for a water treatment system, the clarifier comprising:
a separator region fluidically connected to an inlet of the clarifier and a first outlet of the clarifier; and
a thickening region below the separator region, wherein the thickening region comprises:
a rotatable shaft,
protrusions extending outward from the rotatable shaft, and
a second outlet fluidically connected to the thickening region and positioned between a first section of the rotatable shaft and a second section of the rotatable shaft.

2. A clarifier for a water treatment system, the clarifier comprising:
a separator region fluidically connected to an inlet of the clarifier and a first outlet of the clarifier; and
a thickening region below the separator region, wherein the thickening region comprises:
a rotatable shaft,
protrusions extending outward from the rotatable shaft, and
a second outlet fluidically connected to the thickening region and positioned in a central portion of a clarifier bottom.

3. The clarifier of claim 1, wherein the separator region is configured to produce a first product stream containing a lower concentration of suspended solids than an inlet stream of the clarifier.

4. The clarifier of claim 1, wherein the separator region comprises a plurality of inclined plates.

5. The clarifier of claim 1, wherein the separator region comprises a plurality of corrugated plates.

6. The clarifier of claim 1, wherein the separator region comprises tube settling media.

7. The clarifier of claim 1, wherein the protrusions are helical-shaped.

8. The clarifier of claim 1, wherein the protrusions comprise baffles.

9. The clarifier of claim 1, wherein the clarifier comprises a flat bottom.

10. The clarifier of claim 1, wherein the clarifier comprises a v-shaped bottom.

11. The clarifier of claim 1, wherein the clarifier is coupled to a controller configured to receive an input signal from a sensor monitoring a depth of a sludge blanket in the clarifier, and to deliver an output signal, in response to the input signal, to a pump controlling a flow rate through the second outlet.

12. The clarifier of claim 1, wherein the second outlet is in fluidic communication with a sludge dewatering apparatus downstream of the clarifier.

13. The clarifier of claim 12, wherein the sludge dewatering apparatus is selected from the group consisting of a belt filter press, a plate and frame filter press, and a solid bowl decanter centrifuge.

14. The clarifier of claim 1, wherein the second outlet is in fluidic communication with a sludge holding tank.

15. The clarifier of claim 14, wherein the sludge holding tank is fluidically positioned between the clarifier and a sludge dewatering apparatus.

16. A method of operating a clarifier for a water treatment system, the method comprising:
separating, within a separator region of the clarifier, at least a portion of suspended solids from an aqueous inlet stream to produce:
a first product enriched in water relative to the aqueous inlet stream, the first product directed to a first outlet of the clarifier, and
a second product positioned below the separator region of the clarifier, the second product enriched in solids relative to the aqueous inlet stream, the second product having a solids content of 2% by weight or greater and directed to a second outlet of the clarifier.

17. A method of operating a clarifier for a water treatment system, the method comprising:
separating, within a separator region of the clarifier, at least a portion of suspended solids from an aqueous inlet stream to produce:
a first product enriched in water relative to the aqueous inlet stream, the first product directed to a first outlet of the clarifier, and
a second product positioned below the separator region of the clarifier, the second product enriched in suspended solids relative to the aqueous inlet stream such that the ratio of a mass percentage of the solids in the second product to a mass percentage of solids in the inlet stream is at least about 20 to 1.
